(19) United States
(12) Patent Application Publication
(10) Pub. No.: US 2019/0188619 A1
(43) Pub. Date: Jun. 20, 2019

(54) COLLABORATIVE ENTERPRISE SHARED RESOURCE STATUS SYSTEM

(71) Applicant: Microsoft Technology Licensing, LLC, Redmond, WA (US)

(72) Inventors: Abhishek Kumar Chaturvedi, Bellevue, WA (US); Hongchao Guan, Redmond, WA (US); Philipp Cannons, Seattle, WA (US)

(21) Appl. No.: 15/844,312

(22) Filed: Dec. 15, 2017

(51) Int. Cl. G06Q 10/06; G06F 17/30; G06Q 10/02

(52) U.S. Cl. CPC G06Q 10/06314; G06F 17/30377; G06Q 10/02; G06Q 10/063114; G06F 17/30876

(57) ABSTRACT

A status system suitable for monitoring and maintaining status for shared resources is provided. The status system obtains status for a shared resource from a plurality of users of the shared resource, the status indicating an observed status of the shared resource received via a device of each of the plurality of users. Based on the obtained status from the plurality of users, the status system determines a current status for the shared resource. A central database in a central data storage is updated with the current status for the shared resource. In response to a request for the status of the shared resource, the status system retrieves the current status of the shared resource and causes display of the current status in a user interface.

### TECHNICAL FIELD

The subject matter disclosed herein generally relates to special-purpose machines that facilitate monitoring and maintaining status of resources, including computerized variants of such special-purpose machines and improvements to such variants, and to the technologies by which such special-purpose machines become improved compared to other special-purpose machines that monitor and maintain status of resources. Specifically, the present disclosure addresses systems and methods that monitor and maintain real-time status of shared resources using collaborative inputs selectively retrieved from databases of members of an organization, group, or enterprise.

### BACKGROUND

Conventionally, a modem enterprise has a lot of resources that are shared by an entire organization or certain divisions. Dynamic information about these shared resources are important and useful for maintaining productivity of people using the resources. An example of dynamic information includes availability status of the shared resource. In today's communication system, such as a calendar system, a current approach for managing the shared resource is through IT administrators. This requires IT administrators to manually maintain the information up-to-date for all shared resources. This is not an effective approach since it constrains time of IT administrators, especially when the communication system is being hosted in a cloud service. Additionally, there is no easy way for a user to access status for a shared resource in these conventional systems.

### BRIEF DESCRIPTION OF THE DRAWINGS

Some embodiments are illustrated by way of example and not limitation in the figures of the accompanying drawings.

FIG. 1 is a block diagram illustrating an example environment for maintaining a collaborative enterprise shared resource status system.

FIG. 2 is a block diagram illustrating components within a status system in accordance with an example embodiment.

FIG. 3A-FIG. 3E illustrate example user interfaces for providing and receiving status for a shared resource.

FIG. 4 is a flow diagram of an example method for maintaining real-time status for a shared resource.

FIG. 5 is a flow diagram of an example method for causing presentation of the real-time status of the shared resource.

FIG. 6 is a diagrammatic representation of a machine in an example form of a computing system within which a set of instructions may be executed for causing the machine to perform any one or more of the methodologies discussed herein, according to an example embodiment.

### DETAILED DESCRIPTION

The description that follows describes systems, methods, techniques, instruction sequences, and computing machine program products that illustrate example embodiments of the present subject matter. In the following description, for purposes of explanation, numerous specific details are set forth in order to provide an understanding of various embodiments of the present subject matter. It will be evident, however, to those skilled in the art, that embodiments of the present subject matter may be practiced without some or other of these specific details. Examples merely typify possible variations. Unless explicitly stated otherwise, structures (e.g., structural components, such as modules) are optional and may be combined or subdivided, and operations (e.g., in a procedure, algorithm, or other function) may vary in sequence or be combined or subdivided.

Example methods (e.g., algorithms) and systems (e.g., special-purpose machines) facilitate monitoring and maintaining real-time or current status of shared resources using collaborative inputs selectively retrieved from data stored by members of an enterprise, group, or organization. Shared resources comprise any resource or device that is shared amongst a plurality of users within a particular location or organization. Example of shared resources include, for example, a conference room and any equipment within the conference room (e.g., a projector, a whiteboard, a speaker phone, a conferencing device). The shared resource may also comprise various devices that are not location specific such as a laptop, a portable projector, a car, or any other device or equipment that is temporarily used (e.g., shared) by different individuals within the organization.

In particular, example embodiments provide mechanisms and logic that use a crowd sourcing approach to obtain status for a shared resource. Specifically, users of the shared resource share what they observed as the status of each shared resource they are using or just finished using. In some embodiments, the status is stored into a personal database of the user. A status system selectively propagates the status to other users within a same organization, group, or division. In one embodiment, the status is selectively obtained by the status system and used to update a central database (e.g., within a central data storage) that stores the real-time or current status for each shared resource. Requests for status for a particular shared resource is then received by the status system, which retrieves the status from the central database. The real-time or current status is then displayed on a user interface of a requester in response to the request (real-time status and current status being used interchangeably below).

As a result, one or more of the methodologies described herein facilitate solving the technical problem of maintaining a real-time status system for a plurality of shared resources. As such, one or more of the methodologies described herein may obviate a need for certain efforts or resources that otherwise would be involved in manually updating status of resources and providing of real-time status in response to requests. As a result, resources used by one or more machines, databases, or devices (e.g., within the environment) may be reduced. Examples of such computing resources include processor cycles, network traffic, memory usage, data storage capacity, power consumption, network bandwidth, and cooling capacity.

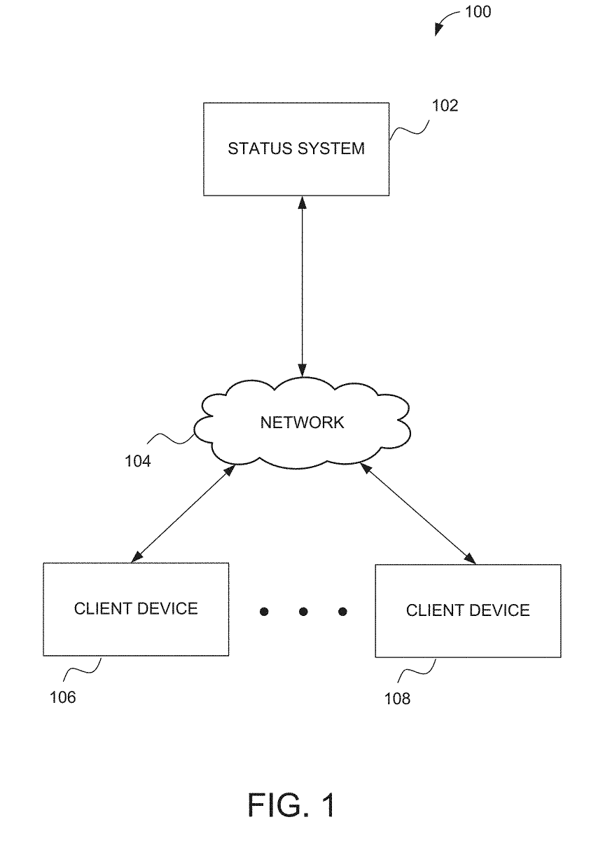

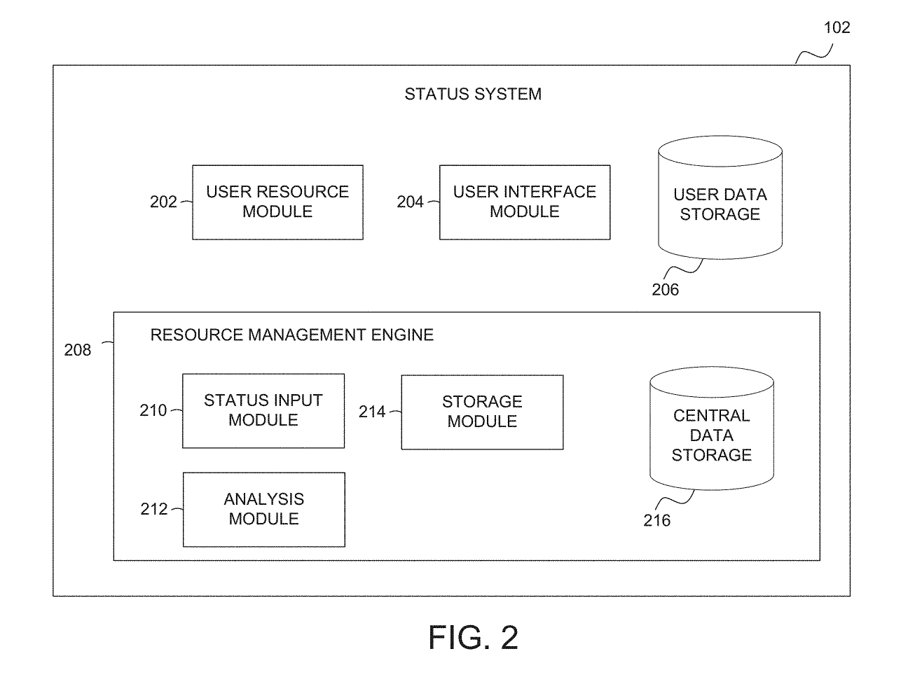

FIG. 1 is a block diagram illustrating an example environment 100 for maintaining up-to-date/real-time status of shared resources using collaborative inputs from a plurality of users of the shared resources. In example embodiments, a status system 102 comprises one or more servers configured to selectively obtain user inputted status, update a central database that maintains the status for the shared resources, and selectively provide real-time status in response to a request. The status system 102 will be discussed in more detail in connection with FIG. 2 below.

The status system 102 is coupled via a network 104 to one or more client devices (e.g., client device 106 and client device 108). One or more portions of the network 104 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, a wireless network, a Wi-Fi network, a WiMax network, a satellite network, a cable network, a broadcast network, another type of network, or a combination of two or more such networks. Any one or more portions of the network 104 may communicate information via a transmission or signal medium. As used herein, “transmission medium” refers to any intangible (e.g., transitory) medium that is capable of communicating (e.g., transmitting) instructions for execution by a machine (e.g., by one or more processors of such a machine), and includes digital or analog communication signals or other intangible media to facilitate communication of such software.

The client devices 106 and 108 are devices of users that are a part of an organization (e.g., building or enterprise) that share resources within the organization. Each user at their respective device 106 or 108 may, via user interfaces, indicate an observed status of one or more shared resources within the organization to the status system 102. Each user at their respective device 106 or 108 may also request, via user interfaces, status information for one or more shared resources from the status system 102. The client devices 106 and 108 may comprise, but are not limited to, a smartphone, tablet, laptop, multi-processor system, microprocessor-based or programmable consumer electronics, game console, set-top box, or any other device that a user utilizes to communicate over the network 104. In example embodiments, the client devices 106 and 108 comprise a display module (not shown) to display information (e.g., in the form of user interfaces). In some embodiments, the client devices 106 and 108 may comprise one or more of a touch screen, camera, keyboard, microphone, and Global Positioning System (GPS) device.

In example embodiments, the client devices 106 and 108 present user interfaces that allow their respective users to view status of shared resources, provide status of shared resources, and reserve shared resources. In some embodiments, the client devices 106 and 108 make service calls to the status system 102 to cause the presentation of the user interfaces (e.g., obtain the data to display the user interfaces). In alternative embodiments, the some of the functions of the status system 102 (discussed below) may be performed at the client devices 106 and 108.

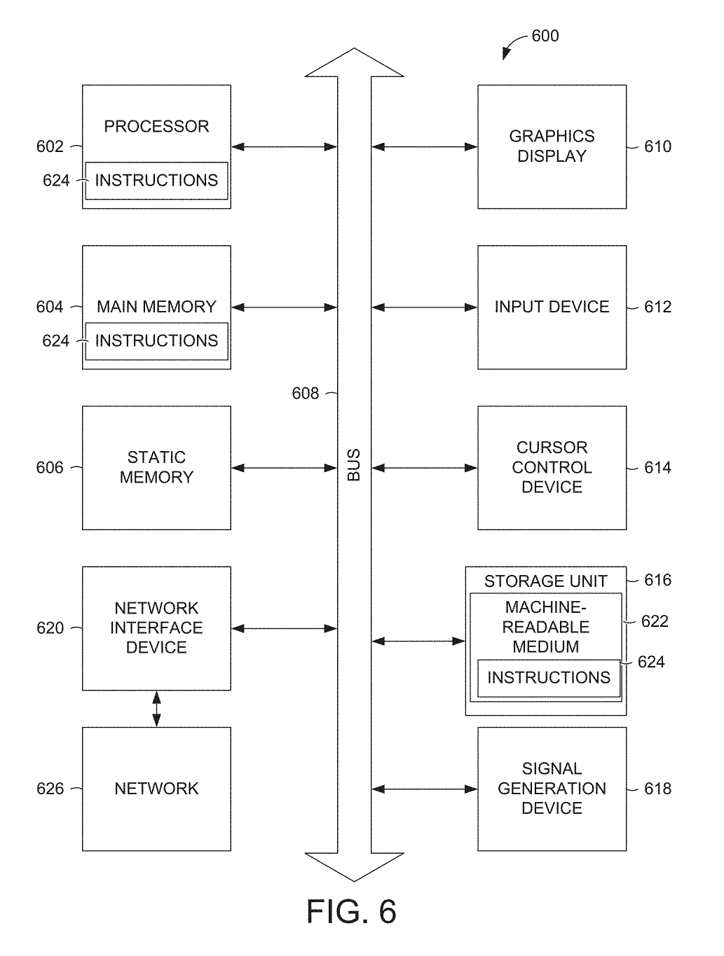

Any of the systems or machines (e.g., databases, devices, servers) shown in, or associated with, FIG. 1 may be, include, or otherwise be implemented in a special-purpose (e.g., specialized or otherwise non-generic) computer that has been modified (e.g., configured or programmed by software, such as one or more software modules of an application, operating system, firmware, middleware, or other program) to perform one or more of the functions described herein for that system or machine. For example, a special-purpose computer system able to implement any one or more of the methodologies described herein is discussed below with respect to FIG. 6, and such a special-purpose computer may accordingly be a means for performing any one or more of the methodologies discussed herein. Within the technical field of such special-purpose computers, a special-purpose computer that has been modified by the structures discussed herein to perform the functions discussed herein is technically improved compared to other special-purpose computers that lack the structures discussed herein or are otherwise unable to perform the functions discussed herein. Accordingly, a special-purpose machine configured according to the systems and methods discussed herein provides an improvement to the technology of similar special-purpose machines.

Moreover, any two or more of the systems or machines illustrated in FIG. 1 may be combined into a single system or machine, and the functions described herein for any single system or machine may be subdivided among multiple systems or machines. Additionally, any number and types of client devices 106 and 108 may be embodied within the environment 100. Furthermore, some components or functions of the environment 100 may be combined or located elsewhere in the environment 100. For example, some of the functions of the server system 102 may be embodied within the client device 106 or 108.

While the embodiment shown in FIG. 1 illustrates a server-client architecture, alternative embodiments may contemplate a peer-to-peer architecture. In the alternative embodiments, the client devices 106 and 108 are communicatively coupled via the network 104 and share status of shared resources directly with each other. In some instances, the client devices 106 and 108 may subscribe to status that is published by certain other client devices or users of these client devices; thus only selectively receiving status information.

FIG. 2 is a block diagram illustrating an example embodiment of components within the status system 102. In example embodiments, the status system 102 performs operations to selectively obtaining user inputted status for shared resources, update a central database that maintains the status for the shared resources, and selectively provide real-time status in response to a request. To enable these operations, the status system 102 comprises a user resource module 202, a user interface module 204, a user data storage 206, and a resource management engine 208 all of Which are configured to communicate with each other (e.g., over a bus, shared memory, or a switch) in accordance with an example embodiment.

The user resource module 202 is configured to manage requests for reservations of shared resources, receive user observed status for shared resources, and manage requests for real-time status of shared resources. The user resource module 202 works in conjunction with the user interface module 204 to receive status and requests, and to provide status in response to requests. Specifically, when a user observed status is reported, the user resource module 202 extracts the status and updates a personal database (e.g., in the user data storage 206) of the user with the status. Conversely, when a request for status is received, the user resource module 202 retrieves the real-time status from the resource management engine 208 and causes the status to be displayed in the user interface via the user interface module 204. In some embodiments, the request for status comprises a request to reserve the shared resource (e.g., a request to reserve a conference room).

In example embodiments, status for a shared resource is only provided to a user that has a permission selling that allows the user to view the status for the shared resource. For example, status for a shared resource in a particular building may only be shared with users that are assigned or associated with the particular building (e.g., users within Building XYZ may only view status of a conference room in Building XYZ). Therefore, the permission setting may indicate the organization, building, or shared resources associated with each user.

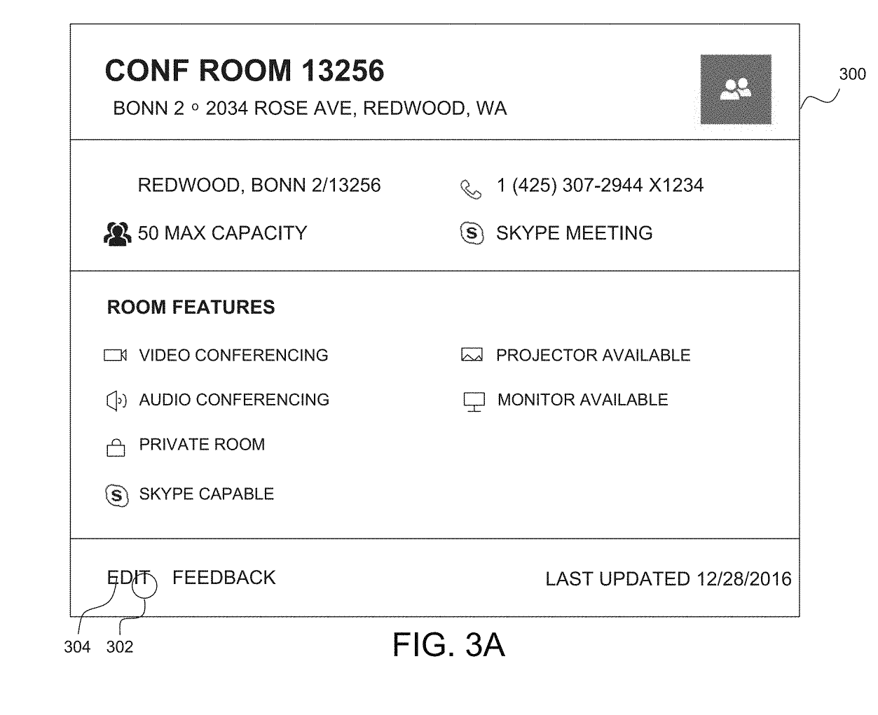

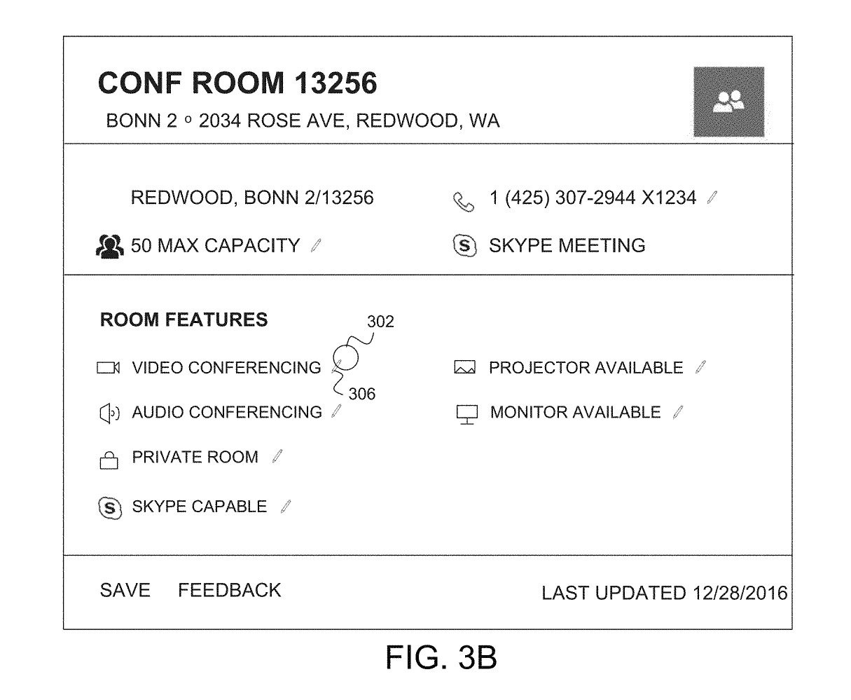

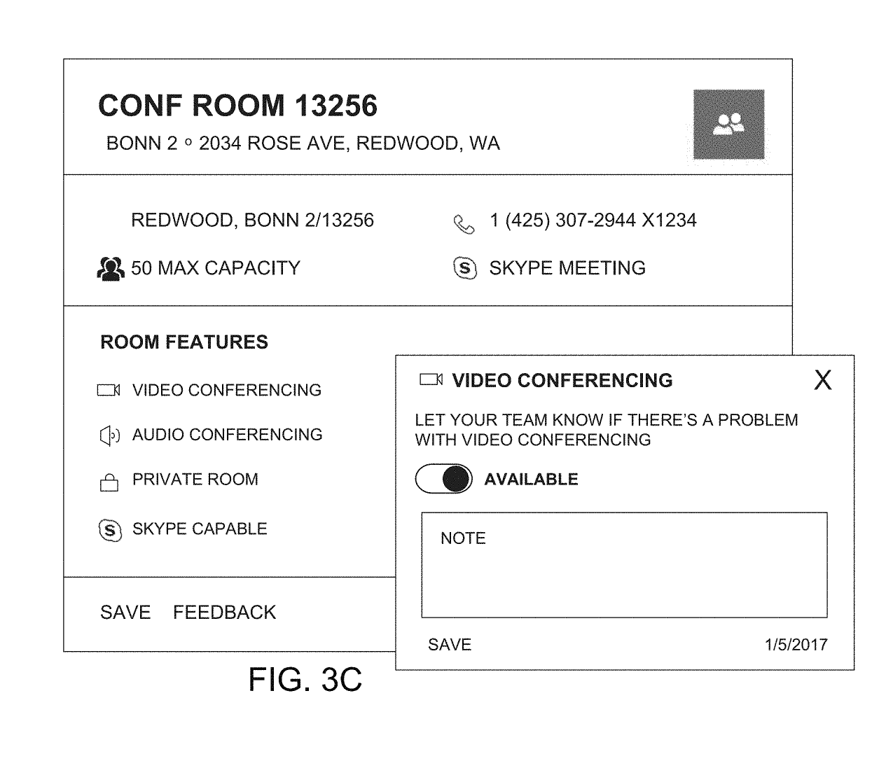

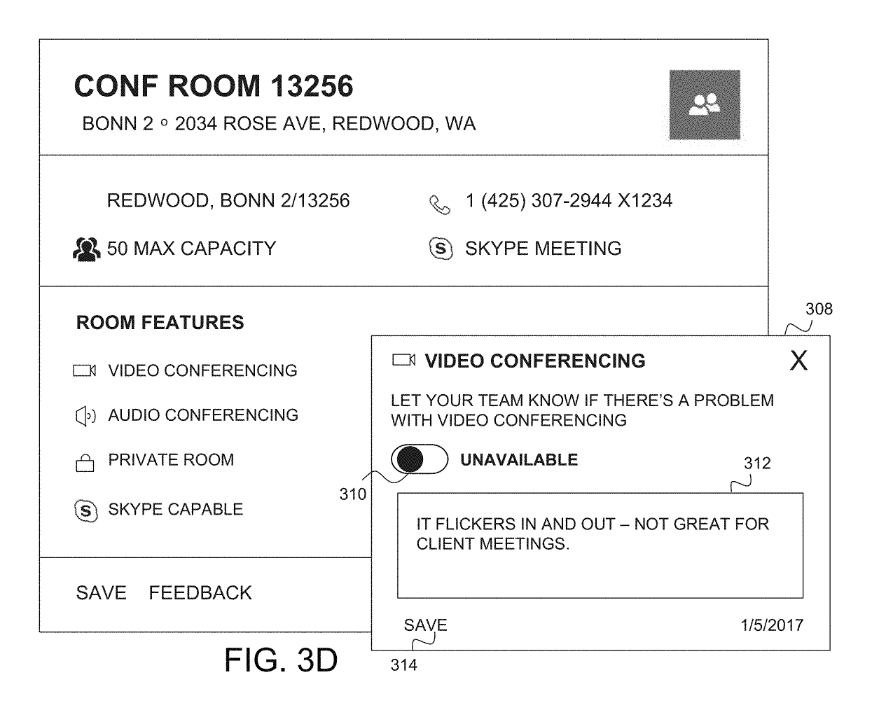

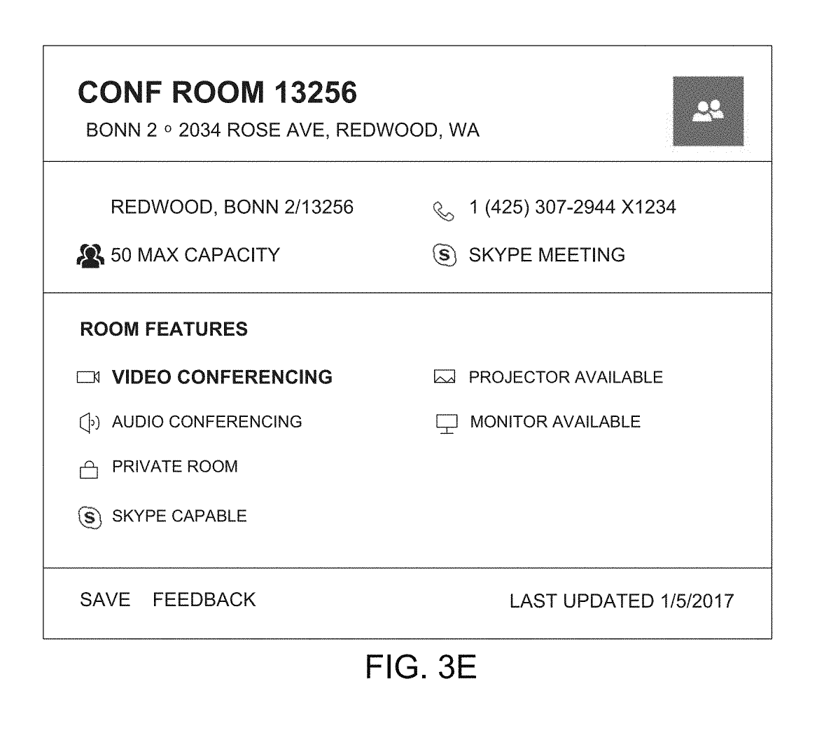

The user interface module 204 is configured to cause presentation of user interfaces on the client devices (e.g., client devices 106 and 108). In example embodiments, the user interface module 204 generates and transmits instructions to the client devices to render and display the user interfaces. In other embodiments, the user interface module 204 may generate and present the user interfaces. The user interface module 204 may provide user interfaces that include elements for reserving shared resources, viewing status for particular shared resources, and inputting updates to status for particular shared resources. Examples of user interfaces are presented below in connection with FIG. 3A through FIG. 3E.

The data storage 206 is configured to store resource information for individual users in user specific data stores or databases (hereinafter collectively referred to as a “personal database”). For instance, each personal database may correspond to a mailbox and/or calendar of the user. In these embodiments, the personal database includes indications of reservations of shared resources (e.g., a meeting that includes a reserved conference room) as well as individual recorded status for particular resources. For example, a user may have recently used conference room A for a meeting and noticed that the conference room is missing a projector or that the projector is broken. The user makes a note of this in, for example, a calendar entry for that meeting. In another example, the user may know that conference room B does not have a white board, and when making a reservation for a meeting that involves conference room B makes a note of the missing white board. All of these notes or status of resources is stored to the user's personal database in the user data storage 206.

While the user data storage 206 is shown to be a part of the status system 102, in sonic embodiments, the user data storage 206 may be located elsewhere in the environment 100 and be communicatively coupled to the status system 102. Additionally, any number of user data storage 206 may be used to store the personal databases of users.

The resource management engine 208 is configured to selectively obtaining status from the user data storage 206, determine the real-time status for each shared resource, and maintain a central data storage 216. Accordingly, the resource management engine 208 comprises a status input module 210, an analysis module 212, a storage module 214, and the central data storage 216 all communicatively coupled, in accordance with one example embodiment.

In example embodiments, the status input module 210 is configured to selectively obtain (e.g., receive, retrieve, access) status for shared resources from the user data storage 206. The status may be obtained periodically (e.g. every hour) or when an event occurs (e.g., a new status update is obtained). Because the shared resources may be specific to a particular location, building, or organization, for example, the status input module 210 may only want to obtain status for shared resources from users that are associated with the location, building, or organization. Accordingly, a permission setting may be accessed (e.g., that is stored in the user database at the user data storage 206) and reviewed for each user providing a status (e.g., status update) that the status input module 210 wants to retrieve and use to update or maintain the real-time status for a particular shared resource. The permission setting may indicate the organization, building, or shared resources associated with each user. If the permission setting allows the retrieval and use of the status, the status may be used to update a status or confirm an existing status of the shared resource.

The analysis module 212 is configured to determine a real-time status for a shared resource. The determination may occur when a status is obtained from the user data storage 206, periodically (e.g. every hour), when an event occurs (e.g., one or more new status is detected or obtained), or when a request for status is received by the user resource module 202. In one embodiment, the real-time status is determined based on timestamps associated with each obtained status. For example, a most recent status based on timestamps may be selected as the real-time status for the shared resource.

In another embodiment, a counter process is used by the analysis module 212 to determine the real-time status for the shared resource. In this embodiment, a first counter or a second counter is updated based the obtained statuses. For example, the first counter may correspond to availability (e.g., physically present at location; in working condition) of the shared resource while the second counter corresponds to unavailability (e.g., missing from location; not in working condition) of the shared resource. The analysis module 212 then selects the status that has the highest count.

In a further embodiment, the analysis module 212 uses an algorithm that takes into consideration user histories and timestamps. For example, the analysis module 212, for each user of a plurality of users having status for a particular shared resource, detects a timestamp of the obtained status, accesses a resource use history for the user (e.g., how often has the user used the resource), and accesses a status report history for the user (e.g. indicating frequency of the user in reporting statuses). Using the timestamp and information from the histories, the analysis module 212 generates a user score. In some cases, the analysis module 212 may apply weights in generating the user score (e.g., timestamp weighted higher than user history). The analysis module 212 then determines a highest user score amongst the plurality of users from whom the statuses have been obtained, whereby the real-time status is the status provided by the user with the highest user score.

The storage module 214 stores and retrieves static (e.g., location of the shared resource; specification of the shared resource) and dynamic information (e.g., status) to/from the central data storage 216. The static information comprises information that is not editable by general users of the status system 102 and is not affected by a change in status. Accordingly, in embodiments where the analysis module 212 determines the real-time status prior to storing to the central database at the central data storage 216, the storage module 214 receives the real-time status from the analysis module 212 and stores the real-time status in a data structure that associates the real-time status with the corresponding shared resource. When a request is received by the user resource module 202, the storage module 214 retrieves the real-time status from the central data storage 216.

In embodiments, where the real-time status is determined by the analysis module 212 at the time a request is received, the storage module 214 may store a plurality of obtained status from the users in the central data storage 216 that was obtained by the status input module 210. The obtained status is then retrieves at the time of the request. The plurality of status is then provided to the analysis module 212 for analysis on-the-fly.

While the central data storage 216 is shown to be a part of the resource management engine 208, in some embodiments, the central data storage 216 may be located elsewhere in the environment 100 and be communicatively coupled to the resource management engine 208. Additionally, any number of central data storage 216 may be used to store the user specific data store.

Any one or more of the components (e.g., modules) described herein may be implemented using hardware alone (e.g., one or more processors of a machine) or a combination of hardware and software. For example, any component described herein may physically include an arrangement of one or more of the processors or configure a processor (e.g., among one or more processors of a machine) to perform the operations described herein for that module. Accordingly, different components described herein may include and configure different arrangements of the processors at different points in time or a single arrangement of the processors at different points in time. Each component (e.g., module) described herein is an example of a means for performing the operations described herein for that component. Moreover, any two or more of these components may be combined into a single component, and the functions described herein for a single component may be subdivided among multiple components. Furthermore, according to various example embodiments, components described herein as being implemented within a single machine, database, or device may be distributed across multiple machines, databases, or devices. The server system 102 may comprise other components not pertinent to example embodiments that are not shown or discussed. Further still, one or more of the components of the server system 102 may be located at the receiver device 106.

FIG. 3A-FIG. 3E illustrate example user interfaces for providing and receiving status for a shared resource, in accordance with example embodiment. The user interfaces are rendered and displayed on the client device (e.g., client device 106 or 108). The user interfaces may be presented, for example, when a user attempts to reserve a resource (e.g., reserve a conference room, laptop, or car), view a meeting invite, or view a calendared meeting.

FIG. 3A illustrates a resource user interface 300 showing shared resources (e.g., room features) available within a conference room. It is noted that the conference room, itself, is also a shared resource. In example embodiments, the resource user interface 300 may be displayed in response to, for example, a request from the user to reserve a shared resource, schedule a meeting, accessing shared resource status, or updated shared resource status. The resource user interface 300 displays both static and dynamic information for the shared resources. For example, static information may include the name of the shared resource (e.g., conference room 13256; projector, monitor), a location of the shared resource (e.g., 2034 Rose Ave, Redwood, Wash.; within conference room 13256), conference room capacity, and contact information for the conference room (e.g., telephone number).

Examples of dynamic information includes status of shared resources. In some instances, the status may be shown textually (e.g., “projector available” or “monitor available”), In other instances, the status is shown with an indication of the shared resource (e.g., a name of the shared resource) being visually distinguished (e.g. a different color; bolded; or grayed out).

In the present example, a user of a device (e.g. the client device 106) wants to provide an edit to the information displayed on the resource user interface 300 (e.g., update or change a status of a shared resource). For example, the user may have recently used the conference room and knows that the status of one of the shared resources is not up-to-date. Accordingly, a selection mechanism e.g., a circle 302) is used to select an edit selection 304.

In response to the selection of the edit selection 304, the resource user interface 300 becomes editable as shown in FIG. 3B (e.g., edit selections are provided on the resource user interface 300). The user may navigate the selection mechanism 302 to a shared resource for which the user wants to update a status. In the example of FIG. 3B, the selection mechanism 302 is navigated to a video conferencing edit selection 306, which is subsequently selected.

The selection of the video conference edit selection 306 causes a status detailed view 308 to be displayed as shown in FIG. 3C. In example embodiments, the status detailed view 308 presents a toggle 310 to indicate whether the shared resource is available and a notes section 312 where the user may provide additional details regarding the status of the shared resource. It is noted that the status detailed view 308 is merely an example and that alternative embodiments may present user editable elements for providing status information in other forms or interfaces. Additionally, while the status detailed view 308 is shown as a pop-up user interface, alternative embodiments may display the status detailed view 308 in a different format.

In the present example, the user indicates via the toggle 310 that the shared resource is not available as illustrated in FIG. 3D. Additionally, the user provides, via the notes section 312, further details as to why the shared resource is unavailable (e.g., “It flickers in and out—not great for client meetings.”). The updated status is saved by selection of a save selection 314. The saving of the status updates the user's personal database (e.g., at the user data storage 206), may cause an update to the real-time status (e.g., at the central data storage), and/or may be provided (or published) to other users having permission settings that allow access to the real-time status for the shared resource.

Once saved, the resource user interface 300 is updated to indicate the real-time status for the shared resource. As illustrated in FIG. 3E, the resource user interface 300 now shows the shared resource (i.e., video conferencing) that was updated to indicate an unavailable status visually distinguished by the user interface module 204. For example, the visually distinguishing may be bolding of an indication of the shared resource or showing the unavailable shared resource in a different color (e.g., red) from available shared resources (e.g., green or black).

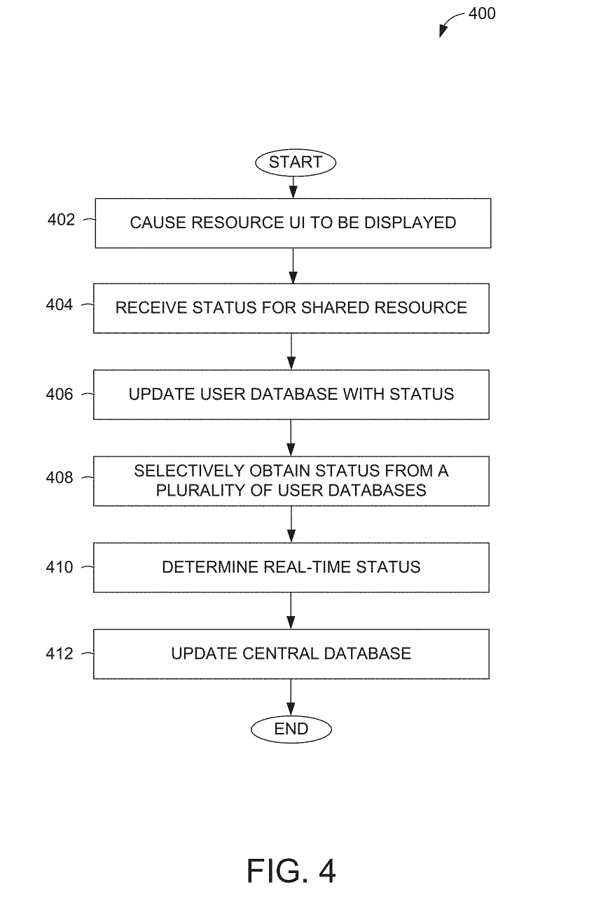

FIG. 4 is a flow diagram of an example method 400 for maintaining real-time status for a shared resource. Operations in the method 400 may be performed by the status system 102, using components (e.g., modules, engines) described above with respect to FIG. 2. Accordingly, the method 400 is described by way of example with reference to the status system 102. However, it shall be appreciated that at least some of the operations of the method 400 may be deployed on various other hardware configurations or be performed by similar components residing elsewhere. For example, some of the operations may be performed at the client device 106 or 108.

In operation 402, the resource user interface is caused to be displayed to a user at a client device (e.g., client device 106 or 108). In example embodiments, the user interface module 204 generates the resource user interface and/or generates and transmits instructions that cause the client device to display the resource user interface. An example of the resource user interface is shown in FIG. 34. The resource user interface may be displayed in response to, for example, a request from the user to reserve a shared resource, schedule a meeting, accessing shared resource status, or updated shared resource status. A user may provide a status for a shared resource via the resource user interface.

In operation 404, status for the shared resource is received. In example embodiments, the user resource module 202 works in conjunction with the user interface module 204 to receive status via the resource user interface. Specifically, when a user observed status is reported, the user resource module 202 extracts the status from the resource user interface.

In operation 406, the received status is used to update the personal database of the user at the user data storage 206. Accordingly, the user resource module 202 updates a data structure associated with the user (e.g., in the user data storage 206) with the status (e.g., updated or revised status).

In operation 408, the status system 102 selectively obtains status from a plurality of user databases. In example embodiments, the status input module 210 selectively obtains (e.g., receive, obtain, retrieve) status inputs for shared resources from the user data storage 206. The status inputs may be obtained periodically (e.g. every hour) or when an event occurs (e.g., a new status update is obtained). In sonic cases, the status input module 210 obtains status inputs for shared resources from users that are associated with a particular location, building, or organization, for example. In these cases, the status input module 210 accesses and reviews permission setting for each user having a status input (e.g., status update) that the status input module 210 wants to retrieve and use to update a status of a shared resource. As a result, the status input module 210 selectively obtains status from the user data storage 206.

In operation 410, the analysis module 212 determines real-time status for one or more shared resources. In one embodiment, the analysis module 212 determines the real-time status based on timestamps associated with each status input obtained in operation 408. For example, a most recent status input, based on timestamps is selected as the real-time status for the shared resource. In another embodiment, a counter process is used by the analysis module 212 to determine the real-time status for the shared resource. For example, a first counter may correspond to availability of the shared resource while a second counter corresponds to unavailability of the shared resource, and the respective counter is updated based of each status obtained in operation 408. The analysis module 212 then selects the status that has the highest count.

In a further embodiment, the analysis module 212 uses an algorithm that takes into consideration user histories and timestamps. In this embodiment, the analysis module 212 may detect, for each user of a plurality of users, a timestamp of the status, accesses a resource use history for the respectively user (e.g., how often has the user used the resource), and accesses a status report history for the user (e.g. indicating frequency of the user in reporting statuses). Using the timestamp and history information, the analysis module 212 generates a user score. In some cases, the analysis module 212 may apply weights in generating the user score (e.g., timestamp weighted higher than user history). The analysis module 212 then determines a highest user score amongst the plurality of users from whom the statuses have been obtained, whereby the real-time status is the status provided by the user with the highest user score. It is noted that other algorithms may be used such that any combination of timestamp, resource use history, or status report history with or without weighting may be used to determine the real-time status.

In operation 412, the central data storage 216 (e.g., central database) is updated with the real-time status by the storage module 214. In example embodiments, the storage module 214 receives the real-time status from the analysis module 212 and stores the real-time status in a data structure that associates the real-time status with the corresponding shared resource.

It is noted that the method 400 of FIG. 4 is directed to a client-server architecture. Alternative embodiments may contemplate a cloud-based architecture there is peer-to-peer. In the alternative embodiments, the client devices 106 and 108 are communicatively coupled via the network 104 and share status of shared resources directly with each other. In some instances, the client devices 106 and 108 may subscribe to status that is published by certain other client devices or users of these client devices (as indicated in their permission settings); thus only selectively receiving status information. In these alternative embodiments, some of the functions and/or modules described above with respect to the status systems 102 may be embodied within the client devices 106 and 108.

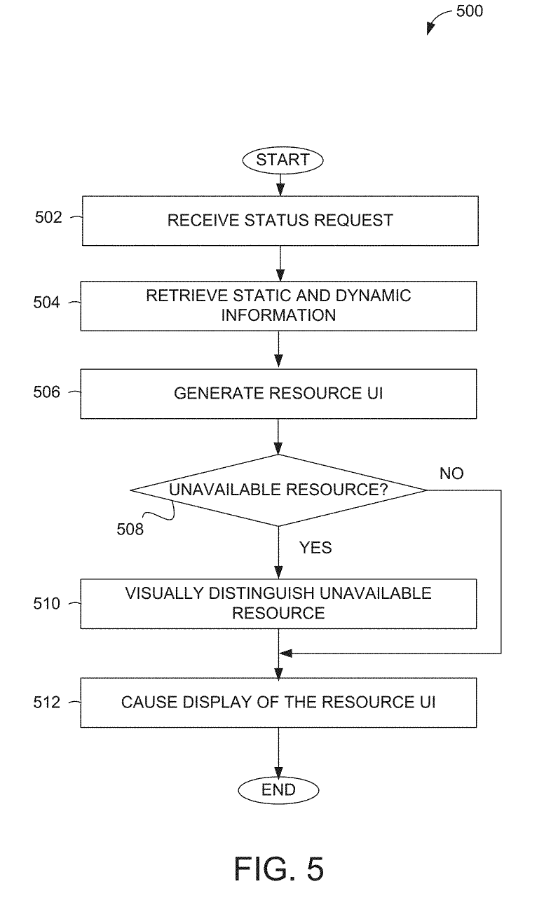

FIG. 5 is a flow diagram of an example method 500 for causing presentation of the real-time status of the shared resource. Operations in the method 500 may be performed by the status system 102, using components (e.g., modules, engines) described above with respect to FIG. 2. Accordingly, the method 500 is described by way of example with reference to the status system 102. However, it shall be appreciated that at least some of the operations of the method 500 may be deployed on various other hardware configurations or be performed by similar components residing elsewhere. For example, some of the operations may be performed at the client device 106 or 108. Therefore, the method 500 is not intended to be limited to the status system 102.

In operation 502, a status request is received by the user resource module 202. In some embodiments, the request is received via the resource user interface. For example, the resource user interface may be displayed in response to a request from the user to reserve a shared resource, schedule a meeting, accessing shared resource status, or updated shared resource status. In some embodiments, the user resource module 202 may, in response to receiving the status request, verify that the user requesting status has permission to access the status. In these embodiments, the user resource module 202 examines permission settings for the user.

In operation 504, the storage module 214 (e.g., in response to instructions from the user resource module 202) retrieves static and dynamic information from the central database. The static information may comprise, for example, name of shared resources, capabilities of the shared resources, a user guide, or any other information for shared resources that is not changeable by users. The dynamic information includes a real-time status for shared resources. The retrieved information is provided to the user resource module 202.

In operations 506, the user interface module 204 generates an initial resource user interface that includes the real-time status for one or more shared resources. A determination is made in operation 508 as to whether a shared resource is unavailable (e.g., by the user resource module 202). If a shared resource is unavailable, an indication of the shared resource is visually distinguished, by the user interface module 204, on the resource user interface in operation 510. The status may be visually distinguished by the indication of the unavailable shared resource being visually distinguished from indications of other shared resources that are available. For example, the name of the unavailable shared resource may be bolded, be in a different color, or grayed out. An example of a resource user interface having an unavailable shared resource is shown in FIG. 3E.

If there are no unavailable shared resources, then the resource user interface is caused to be displayed on a client device (e.g., client device 106 or 10l) by the user interface module 204 without any visually distinguished indications of shared resources. In these instances, the resource user interface may appear as shown in the example of FIG. 3A.

FIG. 6 is a block diagram illustrating components of a machine 600, according to some example embodiments, able to read instructions 624 from a machine-storage medium 622 and perform any one or more of the methodologies discussed herein, in whole or in part. Specifically, FIG. 6 shows the machine 600 in the example form of a computer device (e.g., a computer) within which the instructions 624 (e.g., software, a program, an application, an applet, an app, or other executable code) for causing the machine 600 to perform any one or more of the methodologies discussed herein may be executed, in whole or in part.

For example, the instructions 624 may cause the machine 600 to execute the flows and flow diagrams of FIGS. 4 and 5. The instructions 624 can transform the general, non-programmed machine 600 into a particular machine (e.g., specially configured machine) programmed to carry out the described and illustrated functions in the manner described.

In alternative embodiments, the machine 600 operates as a standalone device or may be connected (e.g., networked) to other machines. The machine 600 may be a server computer, a client computer, a personal computer (PC), a tablet computer, a laptop computer, a netbook, a set-top box (e.g. STB), a personal digital assistant (PDA), a cellular telephone, a smartphone, a web appliance, a network router, a network switch, a network bridge, a power adapter, or any machine 600 capable of executing the instructions 624, sequentially or otherwise, that specify actions to be taken by that machine 600. Further, while only a single machine 600 is illustrated, the term “machine” shall also be taken to include a collection of machines that individually or jointly execute the instructions 624 to perform any one or more of the methodologies discussed herein.

The machine 600 includes a processor 602 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 604, and a static memory 606, which are configured to communicate with each other via a bus 608. The processor 602 may contain microcircuits that are configurable, temporarily or permanently, by some or all of the instructions 624 such that the processor 602 is configurable to perform any one or more of the methodologies described herein, in whole or in part. For example, a set of one or more microcircuits of the processor 602 may be configurable to execute one or more modules (e.g., software modules) described herein.

The machine 600 may further include a graphics display 610 (e.g., a plasma display panel (PDP), a light emitting diode (LED) display, a liquid crystal display (LCD), a projector, a cathode ray tube (CRT), or any other display capable of displaying graphics or video). The machine 600 may also include an alphanumeric input device 612 (e.g., a keyboard or keypad), a cursor control device 614 (e.g., a mouse, a touchpad, a trackball, a joystick, a motion sensor, an eve tracking device, or other pointing instrument), a storage unit 616, a signal generation device 618 (e.g., a sound card, an amplifier, a speaker, a headphone jack, or any suitable combination thereof), and a network interface device 620.

The storage unit 616 includes the machine-storage medium 622 on which are stored the instructions 624 embodying any one or more of the methodologies or functions described herein. The instructions 624 may also reside, completely or at least partially, within the main memory 604, within the processor 602 (e.g., within the processor's cache memory), or both, before or during execution thereof by the machine 600. Accordingly, the main memory 604 and the processor 602 may be considered machine-storage media 622 (e.g., tangible and non-transitory machine-readable media).

In some example embodiments, the machine 600 may be a portable computing device and have one or more additional input components (e.g., sensors or gauges). Examples of such input components include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

### Executable Instructions and Machine-Storage Medium

The various memories (i.e., 604, 606, and/or memory of the processor(s) 602) and/or storage unit 616 may store one or more sets of instructions and data structures (e.g., software) 624 embodying or utilized by any one or more of the methodologies or functions described herein. These instructions, when executed by processor(s) 602 cause various operations to implement the disclosed embodiments.

As used herein, the terms “machine-storage medium,” “device-storage medium,” “computer-storage medium” (referred to collectively as “machine-storage medium 622”) mean the same thing and may be used interchangeably in this disclosure. The terms refer to a single or multiple storage devices and/or media (e.g., a centralized or distributed database, and/or associated caches and servers) that store executable instructions and/or data, as well as cloud-based storage systems or storage networks that include multiple storage apparatus or devices. The terms shall accordingly be taken to include, but not be limited to, solid-state memories, and optical and magnetic media, including memory internal or external to processors. Specific examples of machine-storage media, computer-storage media, and/or device-storage media 622 include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms machine-storage media, computer-storage media, and device-storage media 622 specifically exclude carrier waves, modulated data signals, and other such media, at least some of which are covered under the term “signal medium” discussed below.

### Signal Medium

The term “signal medium” or “transmission medium” shall be taken to include any form of modulated data signal, carrier wave, and so forth. The term “modulated data signal” means a signal that has one or more of its characteristics set or changed in such a matter as to encode information in the signal.

### Computer Readable Medium

The terms “machine-readable medium,” “computer-readable medium” and “device-readable medium” mean the same thing and may be used interchangeably in this disclosure. The terms are defined to include both machine-storage media and signal media. Thus, the terms include both storage devices/media and carrier waves modulated data signals.

The instructions 624 may further be transmitted or received over a communications network 626 using a transmission medium via the network interface device 620 and utilizing any one of a number of well-known transfer protocols (e.g., HTTP). Examples of communication networks 626 include a local area network (LAN), a wide area network (WAN), the Internet, mobile telephone networks, plain old telephone service (POTS) networks, and wireless data networks (e.g., LTE, and WiMAX networks). The term “transmission medium” or “signal medium” shall be taken to include any intangible medium that is capable of storing, encoding, or carrying instructions 624 for execution by the machine 600, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules e.g., code embodied on a machine-storage medium 622 or in a signal medium) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor 602 or a group of processors 602) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field-programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Sonic portions of this specification may be presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine, it is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

### EXAMPLES

Example 1 is a system for maintaining and providing access to current status of shared resources. The system includes one or more processors and a storage medium storing instructions that, when executed by the one or more hardware processors, causes the one or more hardware processors to perform operations comprising obtaining status for a shared resource from a plurality of users of the shared resource, the status indicating an observed status of the shared resource received via a device of each of the plurality of users; based on the obtained status from the plurality of users, determining a current status for the shared resource; updating a central database in a central data storage with the current status for the shared resource; and in response to a request for status of the shared resource, retrieving the current status of the shared resource and causing display of the current status in a user interface.

In example 2, the subject matter of example 1 can optionally include wherein the obtaining the status comprises accessing a personal database for each of the plurality of users, the personal database comprising each user's respective status.

In example 3, the subject matter of examples 1-2 can optionally include wherein the obtaining status comprises determining the plurality of users based on permission setting that allow the status of the plurality of users to be included in determining the current status.

In example 4, the subject matter of examples 1-3 can optionally include wherein the causing display of the current status comprises determining that the request is from an individual having a permission setting that allows the individual to view the current status.

In example 5, the subject matter of examples 1-4 can optionally include wherein the retrieving the current status of the shared resource and causing display of the current status comprises retrieving static and dynamic information for the shared resource, wherein the dynamic information includes the current status and the static information comprises information that is not affected by a change in status.

In example 6, the subject matter of examples 1-5 can optionally include wherein the request for status comprises a calendar request to reserve the shared resource.

In example 7, the subject matter of examples 1-6 can optionally include wherein the causing display comprises visually distinguishing an indication of the shared resource based on the shared resource being unavailable for use.

In example 8, the subject matter of examples 1-7 can optionally include wherein the determining the current status comprises, based on timestamps, using a last status from the obtained status as the current status.

In example 9, the subject matter of examples 1-8 can optionally include wherein the determining the current status comprises updating a first counter or a second counter based on each of the obtained status, a first counter corresponding to availability of the shared resource and a second counter corresponding to unavailability of the shared resource, wherein the current status is determined based on whether the first counter or the second counter has a higher count.

In example 10, the subject matter of examples 1-9 can optionally include wherein the determining the current status comprises detecting a times tamp of the status of each the plurality of users; accessing a resource use history for each of the plurality of users; accessing a status report history for each of the plurality of users, the status report history indicating frequency of each of the plurality of users in reporting status; generating a user score for each of the plurality of users based on the timestamp of the status for each of the plurality of users, resource use history for each of the plurality of users, and status report history for each of the plurality of users; and determining a highest user score amongst the plurality of users, the current status being the status input provided by the user with the highest user score.

Example 11 is a method for maintaining and providing access to current status of shared resources. The method comprises obtaining status for a shared resource from a plurality of users of the shared resource, the status indicating an observed status of the shared resource received via a device of each of the plurality of users; based on the obtained status from the plurality of users, determining a current status for the shared resource; updating, by a hardware processor, a central database in a central data storage with the current status for the shared resource; and in response to a request for status of the shared resource, retrieving the current status of the shared resource and causing display of the current status in a user interface.

In example 12, the subject matter of example 11 can optionally include wherein the obtaining the status comprises accessing a personal database for each of the plurality of users, the personal database comprising each user's respective status.

In example 13, the subject matter of examples 11-12 can optionally include wherein the obtaining status comprises determining the plurality of users based on permission setting that allow the status of the plurality of users to be included in determining the current status.

In example 14, the subject matter of examples 11-13 can optionally include wherein the causing display of the current status comprises determining that the request is from an individual having a permission setting that allows the individual to view the current status.

In example 15, the subject matter of examples 11-14 can optionally include wherein the request for status comprises a calendar request to reserve the shared resource.

In example 16, the subject matter of examples 11-15 can optionally include wherein the causing display comprises visually distinguishing an indication of the shared resource based on the shared resource being unavailable for use.

In example 17, the subject matter of examples 11-16 can optionally include wherein the determining the current status comprises, based on timestamps, using a last status from the obtained status as the current status.

In example, 18, the subject matter of examples 11-17 can optionally include wherein the determining the current status comprises updating a first counter or a second counter based on each of the obtained status, a first counter corresponding to availability of the shared resource and a second counter corresponding to unavailability of the shared resource, wherein the current status is determined based on whether the first counter or the second counter has a higher count.

In example 19, the subject matter of examples 11-18 can optionally include wherein the determining the current status comprises detecting a times tamp of the status of each the plurality of users; accessing a resource use history for each of the plurality of users; accessing a status report history for each of the plurality of users, the status report history indicating frequency of each of the plurality of users in reporting status; generating a user score for each of the plurality of users based on the timestamp of the status for each of the plurality of users, resource use history for each of the plurality of users, and status report history for each of the plurality of users; and determining a highest user score amongst the plurality of users, the current status being the status input provided by the user with the highest user score.

Example 20 is a machine-storage medium for maintaining and providing access to current status of shared resources. The machine-storage medium configures one or more processors to perform operations comprising obtaining status for a shared resource from a plurality of users of the shared resource, the status indicating an observed status of the shared resource received via a device of each of the plurality of users; based on the obtained status from the plurality of users, determining a current status for the shared resource; updating a central database in a central data storage with the current status for the shared resource; and in response to a request for the status of the shared resource, retrieving the current status of the shared resource and causing display of the current status in a user interface.

Although an overview of the present subject matter has been described with reference to specific example embodiments, various modifications and changes may be made to these embodiments without departing from the broader scope of embodiments of the present invention. For example, various embodiments or features thereof may be mixed and matched or made optional by a person of ordinary skill in the art. Such embodiments of the present subject matter may be referred to herein, individually or collectively, by the term “invention” merely for convenience and without intending to voluntarily limit the scope of this application to any single invention or present concept if more than one is, in fact, disclosed.

The embodiments illustrated herein are believed to be described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present invention as represented by the appended claims. The specification and drawings are, accordingly, to be regarded in an illustrative rather than a restrictive sense.

What is claimed is:

1. A system comprising:
one or more hardware processors; and.
a storage medium storing instructions that, when executed by the one or more hardware processors, causes the one or more hardware processors to perform operations comprising:
obtaining status for a shared resource from a plurality of users of the shared resource, the status indicating an observed status of the shared resource received via a device of each of the plurality of users;
based on the obtained status from the plurality of users, determining a current status for the shared resource;
updating a central database in a central data storage with the current status for the shared resource; and
in response to a request for status of the shared resource, retrieving the current status of the shared resource and causing display of the current status in a user interface.

2. The system of claim 1, wherein the obtaining the status comprises accessing a personal database for each of the plurality of users, the personal database comprising each user's respective status.

3. The system of claim 1, wherein the obtaining status comprises determining the plurality of users based on permission setting that allow the status of the plurality of users to be included in determining the current status.

4. The system of claim 1, wherein the causing display of the current status comprises determining that the request is from an individual having a permission setting that allows the individual to view the current status.

5. The system of claim 1, wherein the retrieving the current status of the shared resource and causing display of the current status comprises:
retrieving static and dynamic information for the shared resource,
wherein the dynamic information includes the current status and the static information comprises information that is not affected by a change in status.

6. The system of claim 1, wherein the request for status comprises a calendar request to reserve the shared resource.

7. The system of claim 1, wherein the causing the display comprises visually distinguishing an indication of the shared resource based on the shared resource being unavailable for use.

8. The system of claim 1, wherein the determining the current status comprises, based on timestamps, using a last status from the obtained status as the current status.

9. The system of claim 1, wherein the determining the current status comprises:
updating a first counter or a second counter based on each of the obtained status, a first counter corresponding to availability of the shared resource and a second counter corresponding to unavailability of the shared resource,
wherein the current status is determined based on whether the first counter or the second counter has a higher count.

10. The system of claim 1, wherein the determining the current status comprises:
detecting a timestamp of the status of each the plurality of users;
accessing a resource use history for each of the plurality of users;
accessing a status report history for each of the plurality of users, the status report history indicating frequency of each of the plurality of users in reporting status;
generating a user score for each of the plurality of users based on the timestamp of the status for each of the plurality of users, resource use history for each of the plurality of users, and status report history for each of the plurality of users; and
determining a highest user score amongst the plurality of users, the current status being the status provided by the user with the highest user score.

11. A method comprising:
obtaining status for a shared resource from a plurality of users of the shared resource, the status indicating an observed status of the shared resource received via a device of each of the plurality of users;
based on the obtained status from the plurality of users, determining a current status for the shared resource;
updating, by a hardware processor, a central database in a central data storage with the current status for the shared resource; and
in response to a request for status of the shared resource, retrieving the current status of the shared resource and causing display of the current status in a user interface.

12. The method of claim 11, wherein the obtaining the status comprises accessing a personal database for each of the plurality of users, the personal database comprising each user's respective status.

13. The method of claim 11, wherein the obtaining status comprises determining the plurality of users based on permission setting that allow the status of the plurality of users to be included in determining the current status.

14. The method of claim 11, wherein the causing display of the current status comprises determining that the request is from an individual having a permission setting that allows the individual to view the current status.

15. The method of claim 11, wherein the request for status comprises a calendar request to reserve the shared resource.

16. The method of claim 11, wherein the causing display comprises visually distinguishing an indication of the shared resource based on the shared resource being unavailable for use.

17. The method of claim 11, wherein the determining the current status comprises, based on timestamps, using a last status from the obtained status as the current status.

18. The method of claim 11, wherein the determining the current status comprises:
updating a first counter or a second counter based on each of the obtained status, a first counter corresponding to availability of the shared resource and a second counter corresponding to unavailability of the shared resource,
wherein the current status is determined based on whether the first counter or the second counter has a higher count.

19. The method of claim 11, wherein the determining the current status comprises:
detecting a timestamp of the status of each the plurality of users;
accessing a resource use history for each of the plurality of users;
accessing a status report history for each of the plurality of users, the status report history indicating frequency of each of the plurality of users in reporting status;
generating a user score for each of the plurality of users based on the timestamp of the status for each of the plurality of users, resource use history for each of the plurality of users, and status report history for each of the plurality of users; and
determining a highest user score amongst the plurality of users, the current status being the status provided by the user with the highest user score.

20. A machine-storage medium storing instructions that, when executed by one or more processors of a machine, cause the one or more processors to perform operations comprising:
obtaining status for a shared resource from a plurality of users of the shared resource, the status indicating an observed status of the shared resource received via a device of each of the plurality of users;
based on the obtained status from the plurality of users, determining a current status for the shared resource;
updating a central database in a central data storage with the current status for the shared resource; and
in response to a request for the status of the shared resource, retrieving the current status of the shared resource and causing display of the current status in a user interface.
